(19) United States
(12) Patent Application Publication
(10) Pub. No.: US 2026/0067017 A1
(43) Pub. Date: Mar. 5, 2026

(54) CLOCK AND EVENT SYNCHRONIZATION

(71) Applicant: Thermo Fisher Scientific (Bremen) GmbH, Bremen (DE)

(72) Inventor: Gregor Quiring, Bremen (DE)

(21) Appl. No.: 19/295,124

(22) Filed: Aug. 8, 2025

Related U.S. Application Data
(60) Provisional application No. 63/689,911, filed on Sep. 3, 2024.

(51) Int. Cl. H04J 3/06

(52) U.S. Cl. CPC H04J 3/0667; H04J 3/0644

(57) ABSTRACT

Systems or techniques are provided for clock and event synchronization. In various embodiments, a system can comprise a master clock and one or more agent clocks. In various aspects, the system can synchronize timers in the one or more agent clocks with the master clock based on a timestamp from the master clock. In various aspects, the system can adjust clock speed of the one or more agent clocks based on a comparison of a second timestamp from the master clock and times of the one or more agent clocks at the time of receiving the second timestamp.

### CROSS-REFERENCE TO RELATED APPLICATIONS

This application claims priority to and benefit of U.S. Provisional Application No. 63/689,911, entitled, “CLOCK AND EVENT SYNCHRONIZATION,” which was filed on Sep. 3, 2024. The aforementioned application is hereby incorporated herein by reference in its entirety.

### BACKGROUND

Time sensitive systems call for scheduling with timestamps and a common base event time. However, implementation of such scheduling can be intensive in both computational and hardware costs.

### SUMMARY

The following presents a summary to provide a basic understanding of one or more embodiments. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus or computer program products that facilitate clock and even synchronization with limited hardware and computational costs are provided.

According to one or more embodiments, a system is provided. The system can comprise a master clock and one or more agent clocks. The system can further comprise a non-transitory computer-readable memory that can store computer-executable components. The system can further comprise a processor that can be operably coupled to the non-transitory computer-readable memory and that can execute the computer-executable components stored in the non-transitory computer-readable memory. In various embodiments, the computer-executable components can comprise a synchronization component that synchronizes timers in the one of more agent clocks with a master clock based on a timestamp from the master clock; and an adjustment component that adjusts clock speed of the one or more agent clocks based on a comparison of a second timestamp from the master clock and times of the one or more agent clocks at the time of receiving the second timestamp.

An advantage of the system, and/or of a corresponding computer-implemented method and/or computer program product can be the ability to synchronize clocks of various sub-components of a scientific instrument to allow for a high degree of accuracy of scheduling and execution of various tasks by the sub-components, with reduced hardware and computational resources.

In one or more embodiments, the computer-executable components can further comprise a line delay component that determines line delays between the master clock and the one or more agent clocks, wherein the synchronizing is further based on the line delays.

An advantage of the system, of a corresponding computer-implemented method, and/or computer program product can be the ability to more accurately synchronize clocks of various sub-components of a scientific instrument by accounting for the time delay it takes to send timestamps between the various subcomponents.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, not by way of limitation, in the figures of the accompanying drawings.

FIG. 1 is a block diagram of an example scientific instrument module for performing synchronization of clocks between master and agent modules, in accordance with various embodiments described herein.

FIG. 2 is a flow diagram of an example, non-limiting, method of performing clock synchronization of master and agent modules, in accordance with various embodiments described herein.

FIGS. 3 and 4 illustrate block diagrams of example, non-limiting, scientific instruments that facilitate clock synchronization of master and agent modules, in accordance with one or more embodiments described herein.

FIG. 5 illustrates an example of a master clock and an agent clock, in accordance with one or more embodiments described herein.

FIG. 6 illustrates an example of a master timer, in accordance with one or more embodiments described herein.

FIG. 7 illustrates an example of an agent digital timer, in accordance with one or more embodiments described herein.

FIG. 8 illustrates a flow diagram of an example, non-limiting, computer-implemented method that can facilitate synchronization of agent clocks with a master clock, in accordance with one or more embodiments described herein.

FIG. 9 illustrates a flow diagram of an example, non-limiting, computer-implemented method that can facilitate determination of line delays between master and agent clocks, in accordance with one or more embodiments described herein.

FIG. 10 illustrates an example of a master unit, and one or more agent units spread across multiple computer environments, in accordance with one or more embodiments described herein.

FIG. 11 illustrates a block diagram of an example, non-limiting, operating environment in which one or more embodiments described herein can be facilitated.

### DETAILED DESCRIPTION

The following detailed description is merely illustrative and is not intended to limit embodiments and/or application or utilization of embodiments. Furthermore, there is no intention to be bound by any expressed or implied information presented in the preceding Summary section, or in the Detailed Description section. One or more embodiments are now described with reference to the drawings, wherein like reference numerals are utilized to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Various technological fields call for synchronized actions between sub-systems or components, such as in analytical instruments (e.g., mass spectrometers, electron microscopes etc.) medical devices, robotic and/or automated systems, and others. Often a controller unit (herein referred to a master unit) orchestrates event sequences by sending commands to the various sub-systems (herein referred to as agent units). However, in highly time critical systems, such as those with real-time requirements, or in complex systems wherein an event comprises too many commands to be transferred between the master and agent units in a timely manner, this approach can become a bottleneck. For example, in some complex operations, various subcomponents may need to execute actions within very short time windows, such as within nanoseconds of each other. Sending notifications of tasks executed or instructions to execute a specific action in real-time may not be feasible, as the time to send such signals, and that to process them upon receiving, may exceed the window in which the consecutive actions must be executed.

Accordingly, some systems utilize the concept of scheduling with timestamps and a common event time base. In these systems, various modules and/or sub-components are sent schedules of actions to execute and the times at which they are to be executed. In order for the schedules to be accurately performed, the clocks or timers of the various subcomponents must be synchronized to a base time, as the various sub-components may comprise clocks that run at different speeds due to hardware and/or software considerations, or environmental factors, such as temperature, which may affect hardware performance. However, such a concept is cost intensive both in terms of hardware and computational software required.

To overcome the one or more deficiencies of existing technologies as identified above, one or more embodiments described herein can synchronize timers in one or more agent clocks with a master clock based on a timestamp from the master clock, and adjust clock speed of the one or more agent clocks based on a comparison of a second timestamp from the master clock and times of the one or more agent clocks at the time of receiving the second timestamp. By adjusting the effective clock speed of the one or more agent clocks to that of the master clock, different clock speeds that may arise due to different factors impacting the agent clocks, such as higher ambient temperature increasing clock speed, can be accounted for.

Furthermore, one or more embodiments described herein can adjust the clock speed of the one or more agent clocks based on one or more additional timestamps from the master clock and times of the one or more agent clocks at the time of receiving the one or more additional timestamps. This allows for continual adjustment of the clock speed of the one or more agent clocks to account for changing ambient conditions, to ensure that the agent clocks remain synchronized to the master clock.

One or more embodiments are now described with reference to the drawings, where like referenced numerals are used to refer to like elements throughout. In the following description, for purposes of explanation, numerous specific details are set forth to provide a more thorough understanding of the one or more embodiments. It is evident in various cases, however, that the one or more embodiments can be practiced without these specific details.

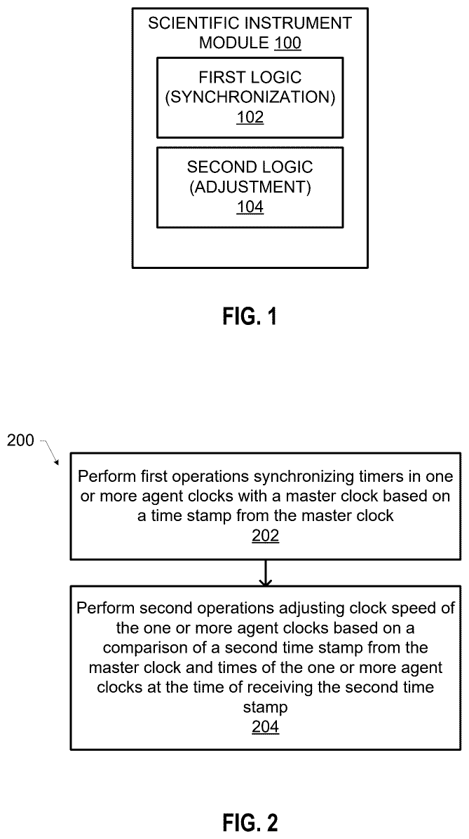

FIG. 1 illustrates an example, non-limiting block diagram of a scientific instrument module 100 in accordance with various embodiments described herein.

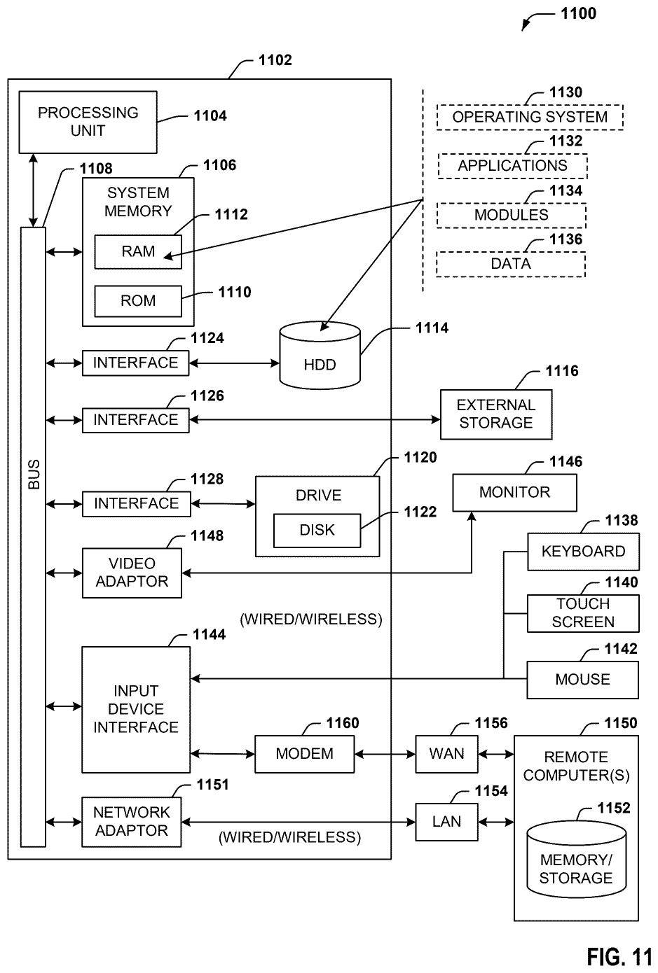

In various embodiments, the scientific instrument module 100 can be implemented by circuitry (e.g., including electrical or optical components), such as a programmed computing device. Logic of the scientific instrument module 100 can be included in a single computing device or can be distributed across multiple computing devices that are in communication with each other as appropriate. Examples of computing devices that may, singly or in combination, implement the scientific instrument module 100 are discussed herein with reference to FIG. 11.

The scientific instrument module 100 may include first logic 102 and second logic 104. As used herein, the term “logic” may include an apparatus that is to perform a set of operations associated with the logic elements. For example, any of the logic elements included in the scientific instrument module 100 may be implemented by one or more computing devices programmed with instructions to cause one or more processing devices of the computing devices to perform the associated set of operations. In a particular embodiment, a logic element may include one or more non-transitory computer-readable media having instructions thereon that, when executed by one or more processing devices of one or more computing devices, cause the one or more computing devices to perform the associated set of operations. As used herein, the term “module” may refer to a collection of one or more logic elements that, together, perform a function associated with the module. Different ones of the logic elements in a module may take the same form or may take different forms. For example, some logic in a module may be implemented by a programmed general-purpose processing device, while other logic in a module may be implemented by an application-specific integrated circuit (ASIC). In another example, different ones of the logic elements in a module may be associated with different sets of instructions executed by one or more processing devices. A module may not include all of the logic elements depicted in the associated drawing; for example, a module may include a subset of the logic elements depicted in the associated drawing when that module is to perform a subset of the operations discussed herein with reference to that module.

In various embodiments, there can be a scientific instrument corresponding to the scientific instrument module 100. In various aspects, the scientific instrument can be any suitable computerized device that can electronically measure some scientifically-relevant, clinically-relevant, or research-relevant characteristic, property, or attribute of an analytical sample (e.g., of a known or unknown mixture, compound, or collection of matter).

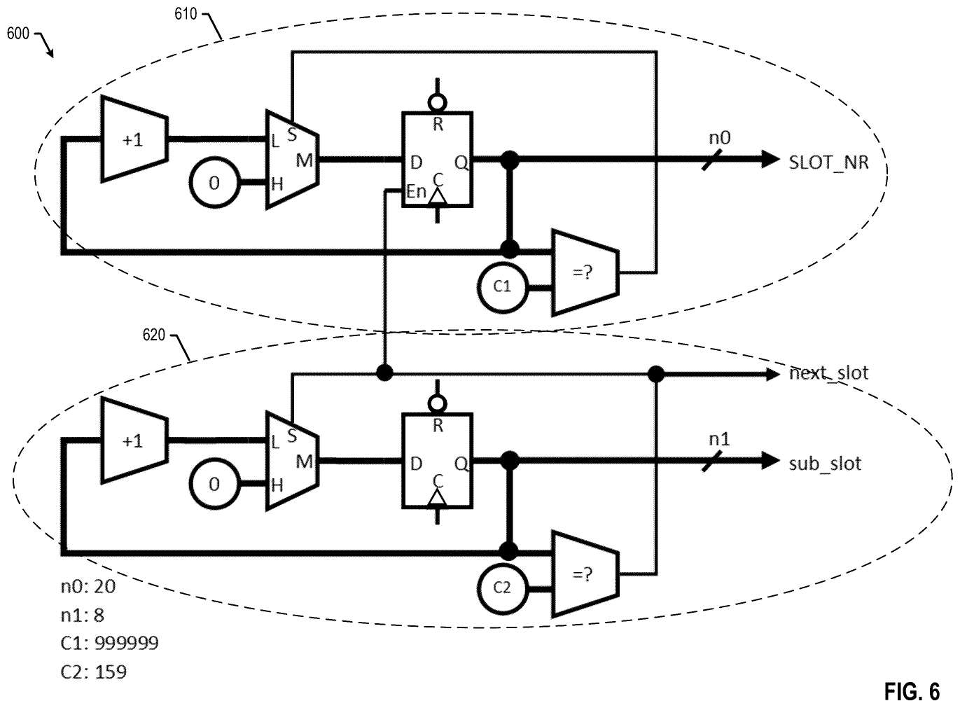

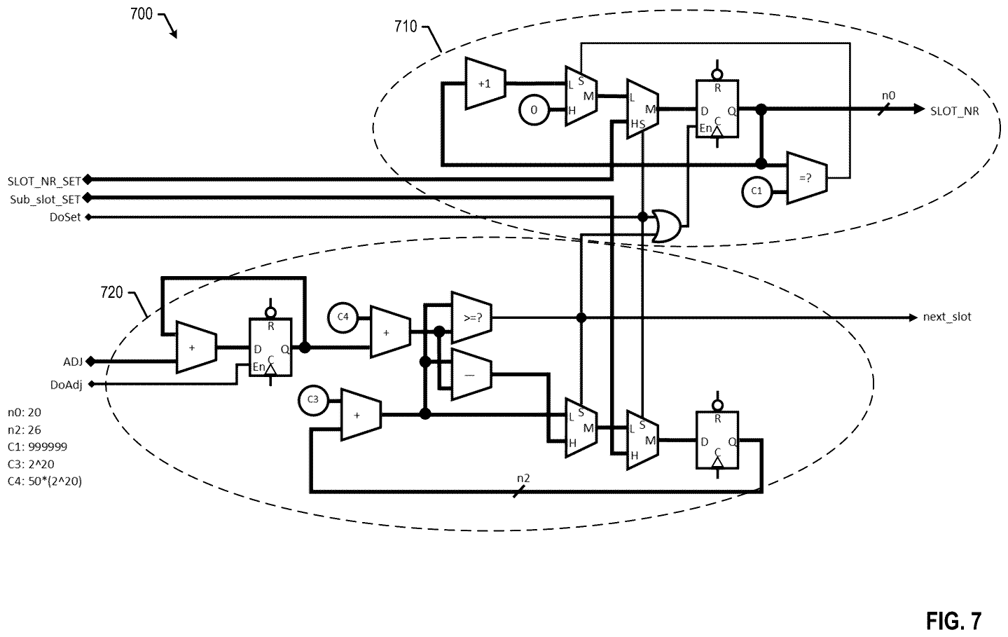

The first logic 102 may synchronize timers in one or more agent clocks with a master clock based on a timestamp from the master clock. For example, the master unit can send a timestamp from its master clock to the clocks of one or more agent clocks. The agent clocks can then synchronize to the timestamp, and account for transmission/line delays (e.g., the amount of time it takes for the timestamp to arrive at the one or more agent clocks). A further discussion of line delays is included below in reference to FIG. 4. Examples of master and agent clocks/timers are discussed below in relation to FIGS. 6 and 7 respectively.

The second logic 104 may adjust clock speed of the one or more agent clocks based on a comparison of a second timestamp from the master clock and times of the one or more agent clocks receiving the second timestamp. For example, a comparison can be made between the current times of the one or more agent clocks and the second timestamp to determine if the one or more agent clocks are running faster or slower than the master clock. Based on this comparison, constants that are used affect the speed of the one or more agent clocks can be adjusted to cause the effective speed of the agent clock to match that of the master clock.

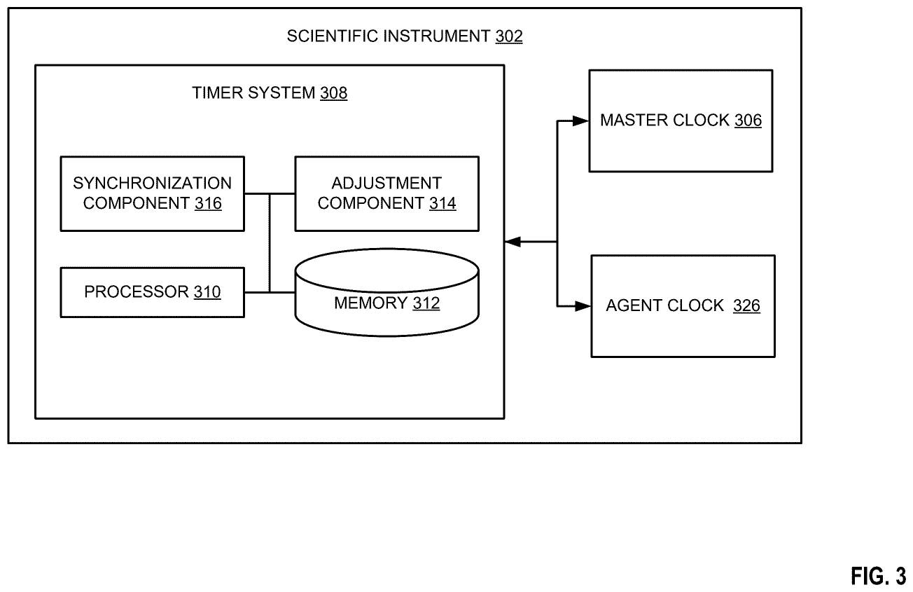

FIG. 2 is a flow diagram of a computer-implemented method 200, in accordance with one or more embodiments described herein. The operations of the computer-implemented method 200 may be used in any suitable setting to perform any suitable operations (e.g., can be performed by or used in conjunction with any of the various modules, computing devices, or graphical user interfaces described with respect to FIGS. 1, 7, 8, 9, 10 and 11). Operations are illustrated once each and in a particular order in FIG. 2, but the operations may be reordered or repeated as desired and appropriate (e.g., different operations performed may be performed in parallel, as suitable).

At 202, first operations may be performed. For example, the first logic 102 of scientific instrument module 100 may perform the operations of 202. The first operations may include synchronizing timers in one or more agent clocks with a master clock based on a timestamp from the master clock.

At 204, second operations may be performed. For example, the second logic 104 of scientific instrument module 100 may perform the operations of 204. The second operations may comprise adjusting clock speed of the one or more agent clocks based on a comparison of a second timestamp from the master clock and times of the one or more agent clocks at the time of receiving the second timestamp.

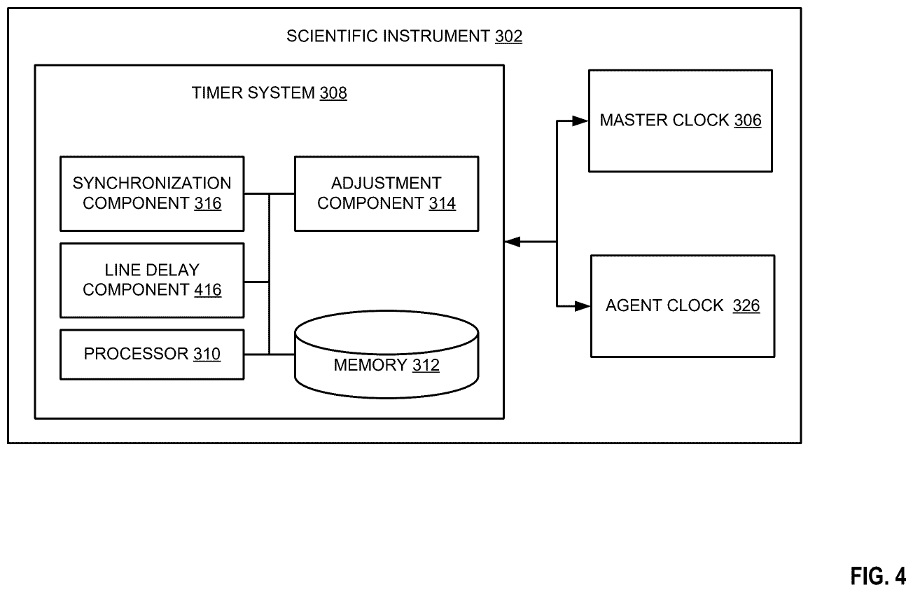

FIG. 3 illustrates a block diagram of an example, non-limiting, scientific instrument that can facilitate clock synchronization, in accordance with one or more embodiments described herein.

In various embodiments, the scientific instrument 302 can comprise a timer system 308. In various cases the timer system 308 can facilitate synchronization between master clock 306 and agent clock 326.

In various aspects, the timer system 308 can comprise a processor 310 (e.g., computer processing unit, microprocessor) and a non-transitory computer-readable memory 312 that is operably or operatively or communicatively connected or coupled to the processor 310. The non-transitory computer-readable memory 312 can store computer-executable instructions which, upon execution by the processor 310, can cause the processor 310 or other components of the timer system 308 (e.g., synchronization component 316 and adjustment component 314) to perform one or more acts. In various embodiments, the non-transitory computer-readable memory 312 can store computer-executable components (e.g., synchronization component 316 and adjustment component 314), and the processor 310 can execute the computer-executable components.

In various embodiments, timer system 308 can comprise synchronization component 316. In various aspects, synchronization component 316 can synchronize timers in the one or more agent clocks with a master clock based on a timestamp from the master clock. In various embodiments, synchronization component 316 can send an instruction to master clock 306 to send a timestamp to agent clock 326, and an instruction to agent clock 326 to synchronize to the timestamp. For example, master clock 306 can broadcast a timestamp, Tm, to agent clock 326. Agent clock 326 can bring the timestamp into its time domain and store the timestamp as Tn.

In various embodiments, timer system 308 can comprise adjustment component 314. In various aspects, adjustment component 314 can adjust clock speed of one or more agent clocks based on a comparison of a second timestamp from master clock 306 and the time of agent clock 326 at the time of receiving the second timestamp. For example, after a period of time has passed since master clock 306 and agent clock 326 were synchronized, adjustment component 314 can instruct master clock 306 to send a second timestamp (Tmo) to agent clock 326. A comparison can then be made between the first timestamp, Tn, and the second timestamp Tmo, to how many event counts master clock 306 has made. Similarly, a comparison can be made between the first timestamp Tn and the time of the agent clock 326 at the time of receiving the second timestamp (referred to herein as Tso). These comparisons can be utilized to determine the relative clock speed differences between master clock 306 and agent clock 326. For example, if the difference between Tn and Tmo is greater than the difference between Tn and Tso, then master clock 306 is faster than agent clock 326, and agent clock 326 can be sped up. Similarly, if the difference between Tn and Tmo is less than the difference between Tn and Tso, then master clock 306 is slower than agent clock 326 and agent clock 326 can be slowed down. Additionally, if the difference between Tn and Tmo is equal to the difference between Tn and Tso, then agent clock 326 and master clock 306 are currently synchronized and running at the same speed.

In one or more embodiments, adjustment component 314 can adjust the effective speed of the one or more agent clocks 326 through adjustment of a timer variable or constant, such that increasing the timer variable or constant decreases the relative clock speed and decreasing the variable or constant increases the relative clock speed. In this manner, adjustment component 314 can facilitate adjustment of the effective speeds of timers, without modification to hardware clock speeds. In various embodiments, this adjustment process can be performed multiple times. For example, the adjustment process can be performed continuously at regular intervals while the scientific instrument 302 is in use. In another example, the adjustment process can be run until the speeds of the agent clock 326 and the master clock 306 are matched a set number of times. For example, if the set number of times is three, and the speeds of agent clock 326 and master clock 306 are matched on three consecutive timestamps, then the adjustment process can end. It should be appreciated that while the diagram shown illustrates a single agent clock, the use of any number of agent clocks is envisioned. Furthermore, in one or more embodiments, adjustment component 314 and synchronization component 316 can be located within master clock 306 and/or agent clock 326.

In various embodiments, master clock 306 and agent clock 326 can be associated with various subcomponents of an analytical instrument or device, or with individual analytical devices that work in concert as part of an analytical system. For example, in one or more embodiments, master clock 306 can be associated with a control component of an electron microscope and agent clock 326 can be associated with a functional component of the electron microscope. In this manner, master clock 306 and agent clock can be used to schedule and execute commands from the control component to the functional component at defined timestamps or intervals. Due to the synchronization and speed adjustment process described above, a high degree of synchronization can be achieved between master clock 306 and one or more agent clocks 326, thereby allowing for a high degree of precision in coordinating events between multiple subcomponents of a scientific instrument or analytical system.

FIG. 4 illustrates a block diagram of an example, non-limiting, scientific instrument that can facilitate clock synchronization, in accordance with one or more embodiments described herein. As shown, scientific instrument 302 can comprise master clock 306, agent clock 326, and timer system 308 as described above in relation to FIG. 3. Timer system 308 of FIG. 4 can further comprise line delay component 416. When synchronizing and adjusting agent clock 326 and master clock 306, the transmission time it takes for a timestamp to travel from master clock 306 to agent clock 326 is non-zero and thus can impact both the synchronization of the clocks, and adjustment of the clock speed. In various embodiments, line delay component 416 can determine line delays between the master clock 306 and agent clock 326. For example, line delay component 416 can instruct master clock 306 to send a reflect signal to agent clock 326 and instruct agent clock 326 to return the reflect signal back to master clock 306 upon receipt. Master clock 306 can then measure the elapsed time between when the reflect signal is sent and when it returns to master clock 306. As the reflect signal has traveled from master clock 306 to agent clock 326 and back, the elapsed time is approximately double that of the time it takes for a signal from master clock 306 to reach agent clock 326 (e.g., the line delay). Furthermore, line delay component 416 can measure the packet transmission time it takes for a packet to be transmitted and/or processed both by a bus of master clock, as well as a bus of agent clock 326. This bus time can then be additionally used, with the line delay, to adjust timestamps between the master and agent to account for transmission and processing time of the timestamp.

Line delay component 416 can then instruct agent clock 326 to store the line delay for use during synchronization and clock speed adjustment. For example, when agent clock 326 receives timestamp Tn from master clock 306, the line delay can be added to timestamp Tn to account for the amount of time it took the timestamp to reach the agent clock 326. Similarly, when master clock 306 sends timestamp Tmo to agent clock 326 during the speed adjustment process, the line delay can be added to Tmo to ensure the comparison to Tso is accurate. In the event that multiple agent clocks are utilized, line delay component 416 can determine the individual line delays for each agent clock, as the line delay will be specific to each agent clock.

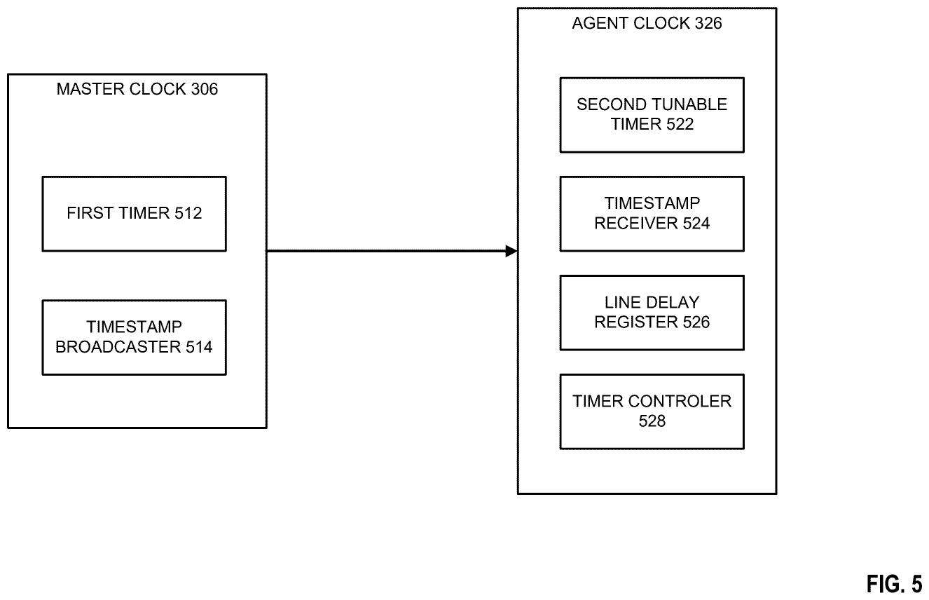

FIG. 5 illustrates an example of a master clock 306 and an agent clock 326, in accordance with one or more embodiments described herein.

As shown, master clock 306 can comprise a first timer 512 and a timestamp broadcaster 514. The first timer 512 can serve as the timekeeper for scheduling of operations, and additionally measure the time required for a reflect signal to return to master clock 306, as part of the determination of the line delay between master clock 306 and agent clock 326. First timer 512 is described in more detail below in relation to FIG. 6. Master clock 306 can further comprise timestamp broadcaster 514, which can send the current timestamp from master clock 306 to agent clock 326.

As shown, agent clock 326 can comprise a second tunable timer 522 that measures time. Second tunable timer 522 is described in more detail below in relation to FIG. 7. Timestamp receiver 524 can receive the timestamps broadcast by timestamp broadcaster 514, such as Tn and Tmo. Line delay register 526 can store the line delay, determined by line delay component 416, between agent clock 326 and master clock 306. Timer controller 528 can synchronize second tunable timer 522 to first timer 512, as well as adjust the clock speed of second tunable timer 522. In one or more embodiments, timer controller 528 can comprise a proportional-integral-derivative (P (I) (D)) controller that continually adjusts the effective clock speed of second tunable timer 522.

FIG. 6 illustrates an example of a master digital timer 600, in accordance with one or more embodiments described herein.

As shown, master digital timer 600 comprises an upper counter 610 and a lower counter 620. In one or more embodiments, lower counter 620 can count cycles and upper counter 610 can count overflows of lower counter 620 (referred to as clock events). For example, as shown, constant C2 of lower counter 620 is set to 159, meaning that lower counter 620 will start counting from 0 and overflow when it reaches 159 (160 clock cycles). When lower counter 620 overflows, then upper counter 610 is signaled to add 1 to its current event count. Accordingly, the time count of timer 600 can be written as SLOT_NR (e.g., the number of clock events): sub_slot (e.g., the current cycle count of the lower counter). It should be appreciated that the numbers utilized for the constants described herein are merely examples, and different constants may be used based on the relative hardware configurations between master digital timer 600 and agent digital timer 700 described below in relation to FIG. 7.

FIG. 7 illustrates an example of an agent digital timer 700 in accordance with one or more embodiments described herein.

As shown, agent digital timer 700 comprises a second lower counter 720 that receives the clock cycle count from lower counter 620 and counts up from the received clock cycle count. Agent digital timer 700 further comprises a second upper counter 710 that counts clock events of second lower counter 720, starting from a clock event count received from upper counter 610. Furthermore, second lower counter 720 can receive a speed adjustment signal based on the clock cycle count of the second lower counter 720 and the clock event count of the second upper counter 710. In one or more embodiments, this speed adjustment signal can be sent by timer controller 528.

As an example, similarly to lower counter 620, second lower counter 720 comprises a constant C4, that when reached, causes second lower counter 720 to overflow and signals second upper counter 710 to add 1 to its count. By adjusting the value of C4, the speed at which agent digital timer 700 counts can be effectively sped up or slowed down, without changing the physical speed at which the circuits cycle. For example, if C4 is increased, then more clock cycles are required to cause an overflow, thereby reducing the rate at which second upper counter 710 increases its event count. Similarly, by decreasing C4, then fewer clock cycles are required to cause an overflow, thereby increasing the rate at which second upper counter 710 increases its event count. In one or more embodiments, master digital timer 600 and agent digital timer 700 can be implemented as physical circuits, as digital circuits, or using devices such as field programable gate arrays, complex programable logic devices, or application specific integrated circuits. An example of the adjustment process is now provided in greater detail below.

Given that the underlying hardware of master digital timer 600 operates at 160 MHz and that the underlying hardware of agent digital timer 700 that operates at 50 MHz, the lowest possible resolution of the events is 100 ns, since this is the smallest common multiple of 6.25 ns and 20 ns. As the resolution of events is chosen to 1 μs, C2 of lower counter 620 is set to 159 (e.g., 160 cycles between clock events). The time stamps which will be sent to agent digital timer 700 will therefore comprise 28 bits: 20 bits for upper counter 610 (e.g., SLOT_NR of FIG. 6) and 8 bits for lower counter 620 (e.g., sub_slot of FIG. 6). The bits from upper counter 610 can be used to override second upper counter 710 via SLOT_NR_SET and the bits from lower counter 620 can be used to override second lower counter 720 via Sub_slot_SET. If the clock sources were perfect, then C3 of agent digital timer 700 could be set as 1 and C4 of agent digital timer 700 could be set at 50, with no additional tunning required. However, the accuracy of crystal oscillators is typically less than +/−100 ppm, which means the actual number of clock cycles for a 50 MHz clock can vary between 49.995.000 and 50.005.000. With an update rate of 10 times per second (100 ms) this amounts to up to 500 clock error of 10 of 1 μs slots. Accordingly, tunning of C4 can be used to correct such errors.

If C3 and C4 are left at 1 and 50 respectively, the adjustment resolution amounts to 2%, which limits the amount of fine-tuning that can be performed. Accordingly, the values of C3 and C4 can be proportionally increased such that the adjustment resolution is decreased, allowing for more accurate finetuning. The values of C3 and C4 can be determined based on the following limitations: the constants are used for arithmetic operations, and therefore too high numbers increase the time and complexity of the arithmetic operations, the constants should be high enough to allow for a low adjustment resolution, and the conversion of the time domain between the master and agent should be considered. In this example illustrated in FIG. 7, C3=2\hat{ }20 and C4=50*(2\hat{ }20) thereby maintaining the ratio between C3 and C4 while decreasing the adjustment resolution sufficiently to allow for a high degree of fine tuning.

Master and agent can be synchronized by sending a timestamp comprising [SLOT_NR: sub_slot] from the master to agent. The SLOT_NR of the master and agent comprise the same format, so no conversion between the two is necessary. However, the sub_slot of the master and agent will differ in format due to the different clock speeds and constant values of the two lower counters. In this example, with clocks of 160 MHz and 50 MHz respectively, the master's sub_slot count of 160 cycles is to map onto the range of 50*(2\hat{ }20)=5*10*16*(2\hat{ }16)=160*5*(2\hat{ }16)=800*(2\hat{ }16). Furthermore, the calculations consider the line delay time, the time to overwrite the agent with the received timestamp (e.g., transfer_clocks), and the time used to perform the conversion calculation (e.g., processing_clocks).

Accordingly, agent_sub_slot=(((line delay+transfer_clocks+master_sub_slot)*5+processing_clocks*16)*10 mod 800)*(2\hat{ }16). Similarly, agent_slot=(masters_slot+int ((((line delay+transfer_clocks+masters_sub_slot)*5+processing_clocks*16)*10)/800) mod 1000000. It should be appreciated that all of these calculations can be achieved by adders and shifters appended to agent digital timer 700 or included in timer controller 528, thereby avoiding the use of multipliers and dividers, and the associated higher hardware and software computation costs.

Therefore, to determine the adjustment to be applied to C4, shown as ADJ, the following can be defined. Tmo (Time_master_old) as the master's corrected timestamp, which was applied at the last broadcast, Tso (T_agent_old) as the agent's timer stamp, which was valid before the latest timestramp (Tn) from the master. As such, ADJ=2* ((Tso−Tn)−(Tmo−Tn)). In this manner an adjustment can be made to C4, thereby changing the effective clock speed of agent digital timer 700 without hardware modifications need to change the clock source used in agent digital timer 700. It should be appreciated that the numbers used in the above example were specific to the master and agent source clock speeds described, and use of master and agent clocks with any clock source speeds are envisioned.

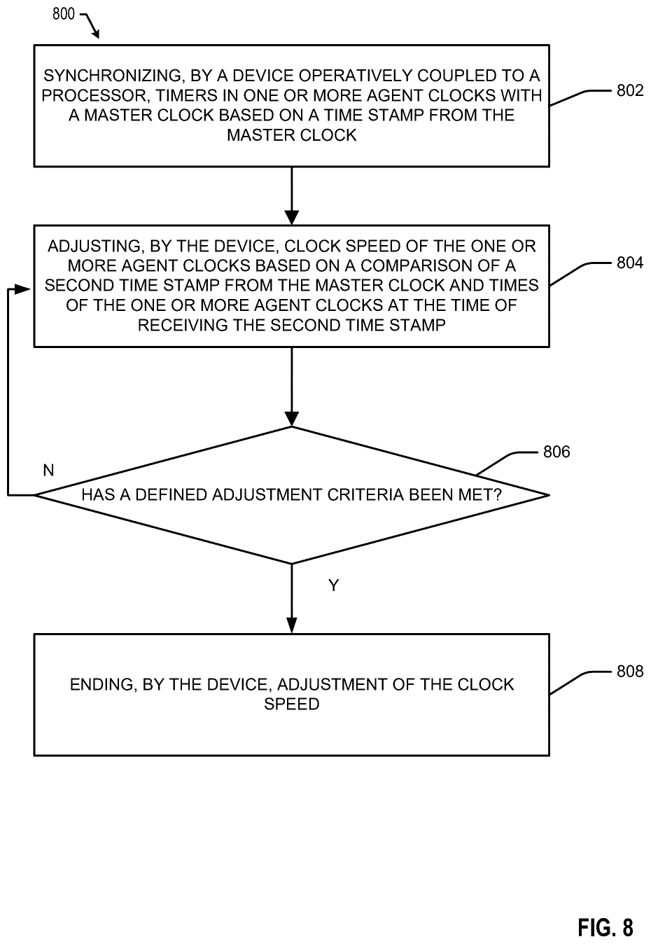

FIG. 8 illustrates a flow diagram of an example, non-limiting, computer-implemented method 800 that can facilitate synchronization of agent clocks with a master clock, in accordance with one or more embodiments described herein.

In various cases, timer system 308 can facilitate the computer-implemented method 800. In various embodiments, act 802 can comprise, synchronizing, by a device (e.g., synchronization component 316) operatively coupled to a processor (e.g., processor 310), timers in one or more agent clocks with a master clock based on a timestamp from the master clock. For example, as described above in relation to FIGS. 3-4, master clock 306 can send a timestamp, Tm, to the one or more agent clocks 326. The one or more agent clocks can add their respective line delays to Tm, to generate the timestamp Tn, and set the tunable timer to timestamp Tn.

In various embodiments, act 804 can comprise adjusting, by the device (e.g., adjustment component 314) clock speed of the one or more agent clocks based on a comparison of a second timestamp from the master clock and times of the one or more agent clocks at the time or receiving the second timestamp. For example, as described above in relation to FIGS. 3-4, master clock 306 can send an additional timestamp Tmo to agent clock 326. The line delay can be added to Tmo and then compared to the time of the agent clock at the moment Tmo was received. These comparisons can be utilized to determine the relative clock speed differences between master clock 306 and agent clock 326. For example, if the difference between Tn and Tmo, including the line delay, is greater than the difference between Tn and Tso, then master clock 306 is faster than agent clock 326, and agent clock 326 can be sped up. Similarly, if the difference between Tn and Tmo is less than the difference between Tn and Tso, then master clock 306 is slower than agent clock 326 and agent clock 326 can be slowed down. Additionally, if the difference between Tn and Tmo is equal to the difference between Tn and Tso, then agent clock 326 and master clock 306 are currently running at the same speed.

In various embodiments, act 806 can comprise determining, by the device (e.g., adjustment component 314), if a defined adjustment criteria has been met. For example, the defined adjustment criteria can comprise a number of clock speed adjustment iterations, a defined number of consecutive adjustment iterations wherein the agent clock speed and the master clock speed were equal, completion of a task by scientific instrument 302, or another criterion. In some embodiments, the adjustment criteria can be set such that the adjustment process runs infinitely at defined intervals. In response to a “YES” determination, method 800 can proceed to act 808 and end the adjustment of clock speed. In response to a “NO” determination, method 800 can return to act 804 and continue iterations of adjustment of the clock speed.

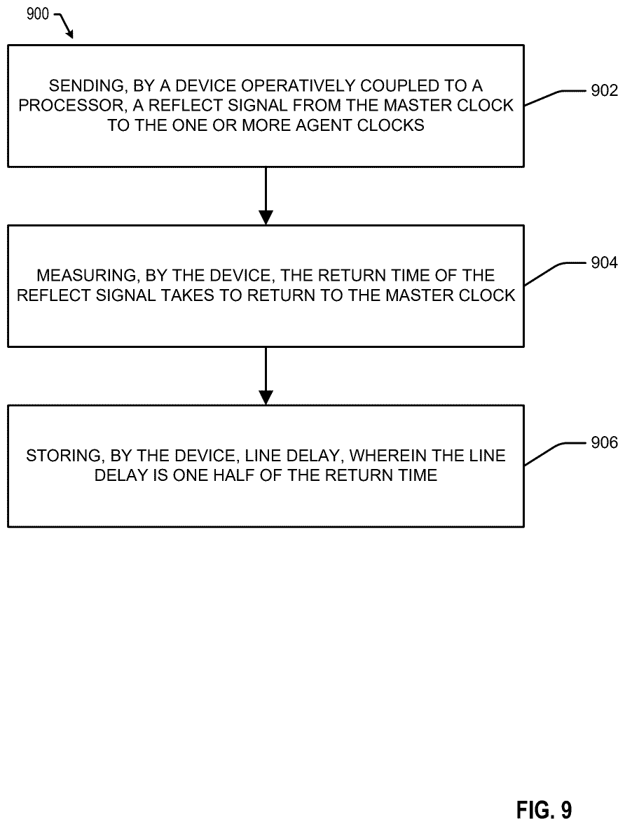

FIG. 9 illustrates a flow diagram of an example, non-limiting, computer-implemented method 900 that can facilitate determination of line delays between master and agent clocks, in accordance with one or more embodiments described herein.

In various embodiments, act 902 can comprise sending, by a device (e.g., master clock 306) operatively coupled to a processor (e.g., processor 310), a reflect signal from the master clock to one or more agent clocks. Upon receipt of the reflect signal, the one or more agent clocks can immediately send the signal back to the master clock.

In various embodiments, act 904 can comprise measuring, by the device (e.g., master clock 306), the return time the reflect signal takes to return to the master clock. For example, the master clock can store a timestamp of when the reflect signal is transmitted and then record the times when the reflect signal returns from each of the one or more agent clocks.

In various embodiments, act 906 can comprise determining, by the device (e.g., agent clock 326), the line delay, wherein the line delay is equal to one half of the return time. For example, as the reflect signal travels the length of the line connecting the master clock to an agent clock twice, the line delay is approximately one half of the total signal travel time. Each of the one or more agent clocks can individually store its respective line delay, as the line delays will vary between agent clocks.

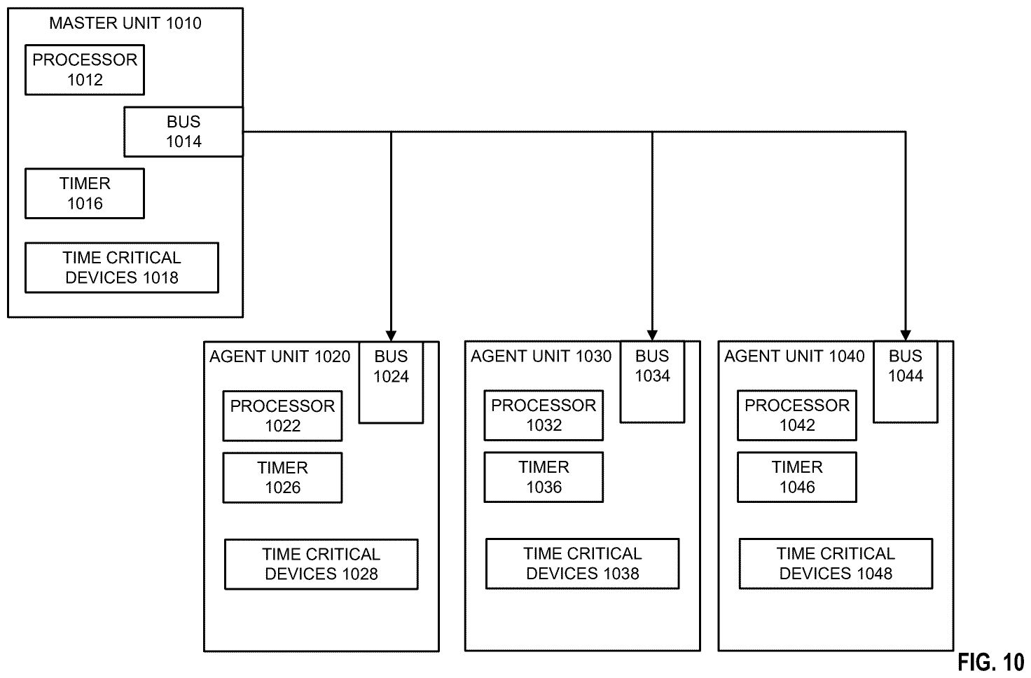

FIG. 10 illustrates an example of a master unit, and one or more agent units spread across multiple computer environments in accordance with one or more embodiments described herein.

In one or more embodiments, a master unit and one or more agent units can be part of differing computer environments, such as computer environment 1100 described below with reference to FIG. 11, with their own processors. For example, as shown, master unit 1010 comprises a processor 1012, a timer 1016, such as timer 600 described above in relation to FIG. 6, and one or more time critical devices 1018 that operate based on timer 1016. Time critical devices 1018 can comprise digital to analog converters (DACs), sampling analog to digital converters (ADCs), stepping motors, pulsers, or similar hardware. Similarly, agent units 1020, 1030, and 1040 can comprise processors 1022, 1032, and 1042 and timers 1026, 1036, and 1046 respectively. Each of master unit 1010, agent unit 1020, agent unit 1030, and agent unit 1040 can further comprise a respective bus (e.g., buses 1014, 1024, 1034, and 1044) that can be used to send timestamps between timer 1016 and the agent timers 1026, 1036, and 1046 to synchronize the agent timers to the master timer and adjust the effective speed of the agent timers as described above in relation to FIGS. 1-9. Accordingly, the time critical devices spread across the one or more agent units can be synchronized with the time critical devices of the master unit.

An advantage of the systems, of corresponding computer-implemented methods, and/or computer program products described herein can be the ability to achieve a high accuracy of synchronization between master and agent clocks with limited communication, hardware, and software computation costs. For example, as described above, scientific instruments and/or analytical systems may require a high degree coordination between various subcomponents that cannot be achieved through execution commands, due to the time need for complex commands to be sent and processed. The systems and/or methods described herein enable a high degree of synchronization between various subcomponents. For example, the methods described herein allow for synchronization between various subcomponents of a scientific instrument, allowing for execution of operations between subcomponents at specific times scheduled in advance, rather than whole instructions being sent between sub-components, allowing for sequencing of more complex coordination between subcomponents. Furthermore, the above-described methods and systems utilize reduced hardware and computational resources when compared to other scheduling methods, thereby decreasing production costs and complexity.

In various instances, machine learning algorithms or models can be implemented in any suitable way to facilitate any suitable aspects described herein. To facilitate some of the above-described machine learning aspects of various embodiments, consider the following discussion of artificial intelligence (AI). Various embodiments described herein can employ artificial intelligence to facilitate automating one or more features or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system or environment from a set of observations as captured via events or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events or data.

Such determinations can result in the construction of new events or actions from a set of observed events or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes or systems (e.g., support vector machines, neural networks, expert systems, Bayesian belief networks, fuzzy logic, data fusion engines, and so on) in connection with performing automatic or determined action in connection with the claimed subject matter. Thus, classification schemes or systems can be used to automatically learn and perform a number of functions, actions, or determinations.

A classifier can map an input attribute vector, z=(z1, z2, z3, z4, zn), to a confidence that the input belongs to a class, as by f(z)=confidence (class). Such classification can employ a probabilistic or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, or probabilistic classification models providing different patterns of independence, any of which can be employed. Classification as used herein also is inclusive of statistical regression that is utilized to develop models of priority.

In order to provide additional context for various embodiments described herein, FIG. 11 and the following discussion are intended to provide a brief, general description of a suitable computing environment 1100 in which the various embodiments of the embodiment described herein can be implemented. While the embodiments have been described above in the general context of computer-executable instructions that can run on one or more computers, those skilled in the art will recognize that the embodiments can be also implemented in combination with other program modules or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments of the aspects described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and a drive 1120, e.g., such as a solid state drive, an optical disk drive, which can read or write from a disk 1122, such as a CD-ROM disc, a DVD, a BD, etc. Alternatively, where a solid state drive is involved, disk 1122 would not be included, unless separate. While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and drive 1120 can be connected to the system bus 1108 by an HDD interface 1124, an external storage interface 1126 and a drive interface 1128, respectively. The interface 1124 for external drive implementations can include at least one or both of Universal Serial Bus (USB) and Institute of Electrical and Electronics Engineers (IEEE) 1194 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1194 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are example and other means of establishing a communications link between the computers can be used.

When used in either a LAN or WAN networking environment, the computer 1102 can access cloud storage systems or other network-based storage systems in addition to, or in place of, external storage devices 1116 as described above, such as but not limited to a network virtual machine providing one or more aspects of storage or processing of information. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Various non-limiting aspects are described in the following examples.

EXAMPLE 1: A system comprising: a master clock; one or more agent clocks; a memory that stores computer executable components; and a processor that executes the computer executable components stored in the memory, wherein the computer executable components comprise: a synchronization component that synchronizes timers in the one or more agent clocks with the master clock based on a timestamp from the master clock; and an adjustment component that adjusts clock speed of the one or more agent clocks based on a comparison of a second timestamp from the master clock and times of the one or more agent clocks at the time of receiving the second timestamp.

EXAMPLE 2: The system of any preceding example, wherein the computer executable components further comprise a line delay component that determines line delays between the master clock and the one or more agent clocks, wherein the synchronizing is further based on the line delays.

EXAMPLE 3: The system of any preceding example, wherein the line delay component determines the line delays by: sending a reflect signal from the master clock to the one or more agent clocks; and measuring return time that the reflect signal takes to return to the master clock, wherein a line delay is one half of the return time.

EXAMPLE 4: The system of any preceding example, wherein the adjustment component further adjusts the clock speed of the one or more agent clocks based on one or more additional timestamps from the master clock and times of the one or more agent clocks at the time of receiving the one or more additional timestamps.

EXAMPLE 5: The system of any preceding example, wherein the one or more agent clocks comprise: a line delay register that stores the line delays of the one or more agent clocks; a timestamp receiver that receives signals from the master clock; a digital timer that measures time; and a timer controller that synchronizes the digital timer to the master clock and adjusts the clock speed of the digital timer.

EXAMPLE 6: The system of any preceding example, wherein the master clock comprises: a master digital timer that measures time; and a timestamp broadcaster which sends signals to the one or more agent clocks.

EXAMPLE 7: The system of any preceding example, wherein the master digital timer comprises: a lower counter that counts clock cycles; and an upper counter that counts overflows of the lower counter.

EXAMPLE 8: The system of any preceding example, wherein the digital timer comprises: a second lower counter that receives the clock cycle count from the lower counter and counts up from the received clock cycle count; and a second upper counter that receives the overflow count of the lower counter and counts overflows of the second lower counter, wherein the second lower counter receives a speed adjustment signal based on the clock cycle count of the second lower counter and the overflow count of the second upper counter.

In various aspects, any combination or combinations of EXAMPLES 1-8 can be implemented.

EXAMPLE 9: A computer-implemented method, comprising: synchronizing, by a device operatively coupled to a processor, timers in one or more agent clocks with a master clock based on a timestamp from the master clock; and adjusting, by the device, clock speed of the one or more agent clocks based on a comparison of a second timestamp from the master clock and times of the one or more agent clocks at the time of receiving the second timestamp.

EXAMPLE 10: The computer-implemented method of any preceding example, further comprising, determining, by the device, line delays between the master clock and the one or more agent clocks, wherein the synchronizing is further based on the line delays between the master clock and the one or more agent clocks.

EXAMPLE 11: The computer-implemented method of any preceding example, wherein the determining the line delays comprises: sending, by the device, a reflect signal from the master clock to the one or more agent clocks; and measuring, by the device, return time that the reflect signal takes to return to the master clock, wherein a line delay is one half of the return time.

EXAMPLE 12: The computer-implemented method of any preceding example, further comprising adjusting, by the device, using a proportional-integral-derivative controller, the clock speed of the one or more agent clocks based on one or more additional timestamps from the master clock and times of the one or more agent clocks at the time of receiving the one or more additional timestamps.

EXAMPLE 13: The computer-implemented method of any preceding example, wherein the master clock comprises: a lower counter that counts clock cycles; and an upper counter that counts overflows of the lower counter.

EXAMPLE 14: The computer-implemented method of any preceding example, wherein the one or more agent clocks comprises: a second lower counter that receives the clock cycle count from the lower counter and counts up from the received clock cycle count; and a second upper counter that receives the overflow count of the lower counter and counts overflows of the second lower counter, wherein the second lower counter receives a speed adjustment signal based on the clock cycle count of the second lower counter and the overflow count of the second upper counter.

In various aspects, any combination or combinations of EXAMPLES 8-14 can be implemented.

EXAMPLE 15: A computer program product comprising a non-transitory computer-readable memory having program instructions embodied therewith, the program instructions executable by a processor to cause the processor to: synchronize, by the processor, timers in one or more agent clocks with a master clock based on a timestamp from the master clock; and adjust, by the processor, clock speed of the one or more agent clocks based on a comparison of a second timestamp from the master clock and times of the one or more agent clocks at the time of receiving the second timestamp.

EXAMPLE 16: The computer program product of any preceding example, wherein the program instructions are further executable by the processor, to cause the processor to: determine, by the processor, line delays between the master clock and the one or more agent clocks wherein the synchronizing is further based on the line delays between the master clock and the one or more agent clocks.

EXAMPLE 17: The computer program product of any preceding example, wherein the determining the line delays causes the processor to: send, by the processor, a reflect signal from the master clock to the one or more agent clocks; and measure, by the processor, return time that the reflect signal takes to return to the master clock, wherein a line delay is one half of the return time.

EXAMPLE 18: The computer program product of any preceding example, wherein the program instructions are further executable by the processor, to cause the processor to: adjust, by the processor, the clock speed of the one or more agent clocks based on one or more additional timestamps from the master clock and times of the one or more agent clocks at the time of receiving the one or more additional timestamps.

EXAMPLE 19: The computer program product of any preceding example, wherein the master clock comprises: a lower counter that counts clock cycles; and an upper counter that counts overflows of the lower counter.

EXAMPLE 20: The computer program product of any preceding example, wherein the one or more agent clocks comprises: a second lower counter that receives the clock cycle count from the lower counter and counts up from the received clock cycle count; and a second upper counter that receives the overflow count of the lower counter and counts overflows of the second lower counter, wherein the second lower counter receives a speed adjustment signal based on the clock cycle count of the second lower counter and the overflow count of the second upper counter.

In various aspects, any combination or combinations of EXAMPLES 15-20 can be implemented.

In various aspects, any combination or combinations of EXAMPLES 1-20 can be implemented.

What is claimed is:

1. A system comprising:
a master clock;
one or more agent clocks;
a memory that stores computer executable components; and
a processor that executes the computer executable components stored in the memory, wherein the computer executable components comprise:
a synchronization component that synchronizes timers in the one or more agent clocks with the master clock based on a timestamp from the master clock; and
an adjustment component that adjusts clock speed of the one or more agent clocks based on a comparison of a second timestamp from the master clock and times of the one or more agent clocks at the time of receiving the second timestamp.

2. The system of claim 1, wherein the computer executable components further comprise a line delay component that determines line delays between the master clock and the one or more agent clocks, wherein the synchronizing is further based on the line delays.

3. The system of claim 2, wherein the line delay component determines the line delays by:
sending a reflect signal from the master clock to the one or more agent clocks; and
measuring return time that the reflect signal takes to return to the master clock, wherein a line delay is one half of the return time.

4. The system of claim 1, wherein the adjustment component further adjusts the clock speed of the one or more agent clocks based on one or more additional timestamps from the master clock and times of the one or more agent clocks at the time of receiving the one or more additional timestamps.

5. The system of claim 2, wherein the one or more agent clocks comprise:
a line delay register that stores the line delays of the one or more agent clocks;
a timestamp receiver that receives signals from the master clock;
a digital timer that measures time; and
a timer controller that synchronizes the digital timer to the master clock and adjusts the clock speed of the digital timer.

6. The system of claim 5, wherein the master clock comprises:
a master digital timer that measures time; and
a timestamp broadcaster which sends signals to the one or more agent clocks.

7. The system of claim 6, wherein the master digital timer comprises:
a lower counter that counts clock cycles; and
an upper counter that counts overflows of the lower counter.

8. The system of claim 7, wherein the digital timer comprises:
a second lower counter that receives the clock cycle count from the lower counter and counts up from the received clock cycle count; and
a second upper counter that receives the overflow count of the lower counter and counts overflows of the second lower counter, wherein the second lower counter receives a speed adjustment signal based on the clock cycle count of the second lower counter and the overflow count of the second upper counter.

9. A computer-implemented method, comprising:
synchronizing, by a device operatively coupled to a processor, timers in one or more agent clocks with a master clock based on a timestamp from the master clock; and
adjusting, by the device, clock speed of the one or more agent clocks based on a comparison of a second timestamp from the master clock and times of the one or more agent clocks at the time of receiving the second timestamp.

10. The computer-implemented method of claim 9, further comprising, determining, by the device, line delays between the master clock and the one or more agent clocks, wherein the synchronizing is further based on the line delays between the master clock and the one or more agent clocks.

11. The computer-implemented method of claim 10, wherein the determining the line delays comprises:
sending, by the device, a reflect signal from the master clock to the one or more agent clocks; and
measuring, by the device, return time that the reflect signal takes to return to the master clock, wherein a line delay is one half of the return time.

12. The computer-implemented method of claim 9, further comprising adjusting, by the device, using a proportional-integral-derivative controller, the clock speed of the one or more agent clocks based on one or more additional timestamps from the master clock and times of the one or more agent clocks at the time of receiving the one or more additional timestamps.

13. The computer-implemented method of claim 10, wherein the master clock comprises:
a lower counter that counts clock cycles; and
an upper counter that counts overflows of the lower counter.

14. The computer-implemented method of claim 13, wherein the one or more agent clocks comprises:
a second lower counter that receives the clock cycle count from the lower counter and counts up from the received clock cycle count; and
a second upper counter that receives the overflow count of the lower counter and counts overflows of the second lower counter, wherein the second lower counter receives a speed adjustment signal based on the clock cycle count of the second lower counter and the overflow count of the second upper counter.

15. A computer program product comprising a non-transitory computer-readable memory having program instructions embodied therewith, the program instructions executable by a processor to cause the processor to:
synchronize, by the processor, timers in one or more agent clocks with a master clock based on a timestamp from the master clock; and
adjust, by the processor, clock speed of the one or more agent clocks based on a comparison of a second timestamp from the master clock and times of the one or more agent clocks at the time of receiving the second timestamp.

16. The computer program product of claim 15, wherein the program instructions are further executable by the processor, to cause the processor to:
determine, by the processor, line delays between the master clock and the one or more agent clocks wherein the synchronizing is further based on the line delays between the master clock and the one or more agent clocks.

17. The computer program product of claim 16, wherein the determining the line delays causes the processor to:
send, by the processor, a reflect signal from the master clock to the one or more agent clocks; and
measure, by the processor, return time that the reflect signal takes to return to the master clock, wherein a line delay is one half of the return time.

18. The computer program product of claim 15, wherein the program instructions are further executable by the processor, to cause the processor to:
adjust, by the processor, the clock speed of the one or more agent clocks based on one or more additional timestamps from the master clock and times of the one or more agent clocks at the time of receiving the one or more additional timestamps.

19. The computer program product of claim 16, wherein the master clock comprises:
a lower counter that counts clock cycles; and
an upper counter that counts overflows of the lower counter.

20. The computer program product of claim 19, wherein the one or more agent clocks comprises:
a second lower counter that receives the clock cycle count from the lower counter and counts up from the received clock cycle count; and
a second upper counter that receives the overflow count of the lower counter and counts overflows of the second lower counter, wherein the second lower counter receives a speed adjustment signal based on the clock cycle count of the second lower counter and the overflow count of the second upper counter.
